(19) United States
(12) Patent Application Publication
(10) Pub. No.: US 2005/0229397 A1
(43) Pub. Date: Oct. 20, 2005

(54) Package opener

(76) Inventors: Gabe Neiser, Port Jefferson Station, NY (US); Richard Leifer, Melville, NY (US)

Correspondence Address: KEUSEY, TUTUNJIAN & BITETTO, P.C., 14 VANDERVENTER AVENUE, SUITE 128, PORT WASHINGTON, NY, 11050, US

(21) Appl. No.: 10/943,345

(22) Filed: Sep. 17, 2004

Related U.S. Application Data
(63) Continuation-in-part of application No. 10/785,686, filed on Feb. 24, 2004, now abandoned.

(51) Int. Cl. B67B 7/00

(52) U.S. Cl. 30/2

(57) ABSTRACT

The clamshell package opener includes a driver gear and an idler gear that are compressed against a surface of the package. As the gears are compressed to hold the package, a cutting blade is positioned so as to puncture the clamshell package in the area adjacent the gears. Once the clamshell package has been punctured, the driver gear is rotated while the two gears are maintaining frictional engagement with the package. The rotation of the driver gear causes the package to pass through the gears while being cut by the cutting blade. This action can be performed anywhere along the package and can also be done around the outer periphery edge of the same.

### RELATED APPLICATION INFORMATION

This application is a Continuation in Part of co-pending U.S. patent application Ser. No. 10/785,686 filed Feb. 24, 2004.

### BACKGROUND OF THE INVENTION

1. Field of the Invention

The present invention relates to clamshell packaging, and more particularly, it relates to an opener for use with clamshell packaging.

2. Description of the Prior Art

The use of clamshell packaging is very widespread throughout the retail industry. The implementation of such packaging has enabled manufacturers to provide safe packaging for their products, while at the same time enable the clear display of the product and/or product inserts without costly additions to the packaging process.

In addition, the technology of the clamshell manufacturing process has also enabled the built in hanger, or feet to allow the package to be hung on a display rack or stand on a display counter without the requirement of additional hangers or supports. Thus, for at least the above reasons, clamshell packages have become commonplace in the retail world.

Clamshell packaging, however, suffers from one major drawback; they are very difficult to open once they have been sealed, or welded closed during the manufacturing process. The sealing or welding is generally performed along the outer periphery of the clam shell, or the welded flange adjacent the edge of the package. The plastic used in these packages is strong and difficult, if not impossible to rip open. As such, the purchaser is often required to cut the package open with a sharp razor with an exposed blade or knife, which subjects the purchaser to a high possibility of hurting themselves due to the unusual shapes of the clamshell packages. Often times during the opening of these clamshell packages, the purchaser is either injured, or the contents of the package are damaged.

Thus, it would be desirable to provide a device for easily, conveniently and safely opening a clamshell package without damaging the contents thereof. It is also desirable to provide a device for opening a clamshell package that does not have an exposed blade and thereby eliminates the possibility for user interaction with an exposed blade of a package opening device.

### SUMMARY OF THE INVENTION

It is therefore an aspect of the invention to provide a clamshell package opener that provides a safe and easy way for opening such packages.

It is yet another aspect of the invention to provide a clamshell package opener that does not subject the user to exposure to sharp instruments.

A further aspect of the invention is to provide a clamshell package opener that does not damage the contents of such package.

These and other aspects are achieved in accordance with an embodiment of the invention wherein the clamshell package opener includes means for gripping the clamshell package, a cutting device for engaging and puncturing the clamshell package in response to closing of the gripping means, and means for advancing the clamshell package after the cutting device has punctured the package.

In accordance with other embodiments, the clamshell package opener includes a first arm having two opposing ends, a second arm pivotally connected to the first arm and having two opposing ends, a first gear rotatably mounted on one end of the first arm, a second gear rotatably mounted on one end of the second arm that is opposite said first gear, and a cutting device disposed on one of the arms adjacent one of said gears, the cutting device puncturing the clamshell package at or adjacent to the welded flange when said arms are pivotally closed.

The pivotal closing movement of the first and second arms causes the first and second gears to move closer to each other and engage the clamshell package disposed there between.

Other objectives and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings wherein like reference numerals denote similar components throughout the views:

FIG. 1 is a perspective view of an exemplary clamshell package;

FIG. 2 is a top view of an exemplary clamshell package;

FIG. 3 is a bottom view of an exemplary clamshell package;

FIG. 4a is a side view of an exemplary clamshell package;

FIG. 4b is an enlarge view of the welded edge of an exemplary clamshell package;

FIG. 5 is a cross section view of the exemplary clamshell package take along line 5-5 of FIG. 2;

FIG. 6 is a plan view of the clamshell opener according to an aspect of the present invention;

FIG. 7a is a plan view of the top handle of the clamshell opener according to an embodiment of the invention;

FIG. 7b is a plan view of the bottom handle of the clamshell opener according to an embodiment of the invention;

FIG. 8a is a schematic view of the engagement of the clamshell opener and the welded flange of a clamshell package according to en embodiment of the invention;

FIG. 8b is a schematic view of the operation of the clamshell opener according to an embodiment of the invention;

FIG. 9 is a plan view of the package opener according to another embodiment of the invention;

FIG. 10 is a plan view of the package opener according to another embodiment of the invention; and

FIG. 11 is plan view of the package opener according to another embodiment of the invention.

### DETAILED DESCRIPTION OF PREFERRED EMBODIMENTS

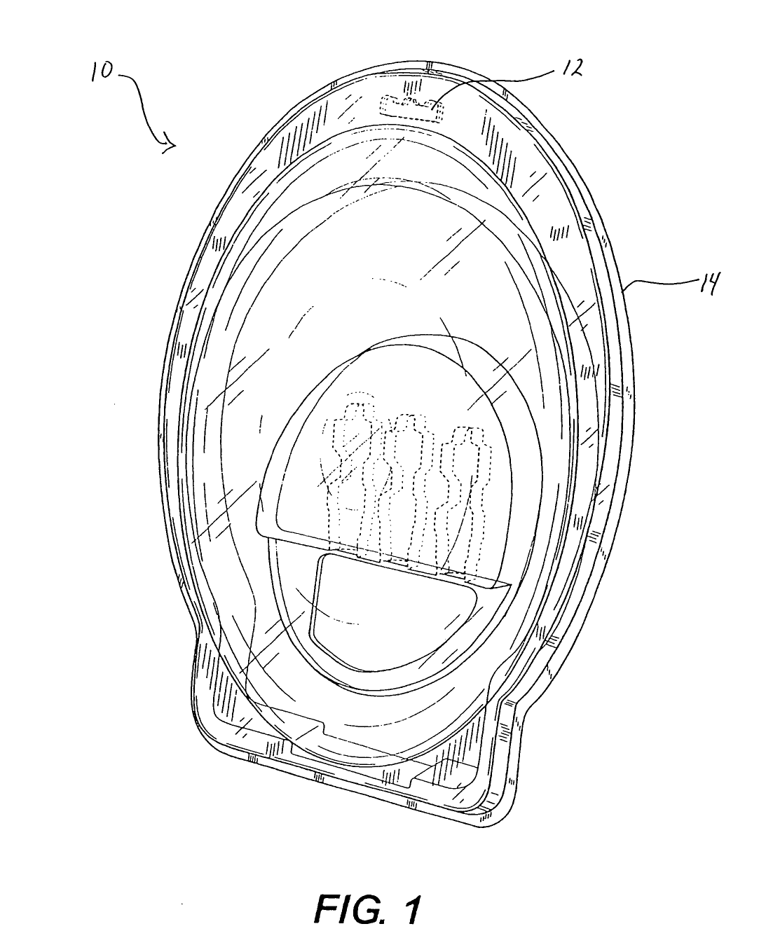

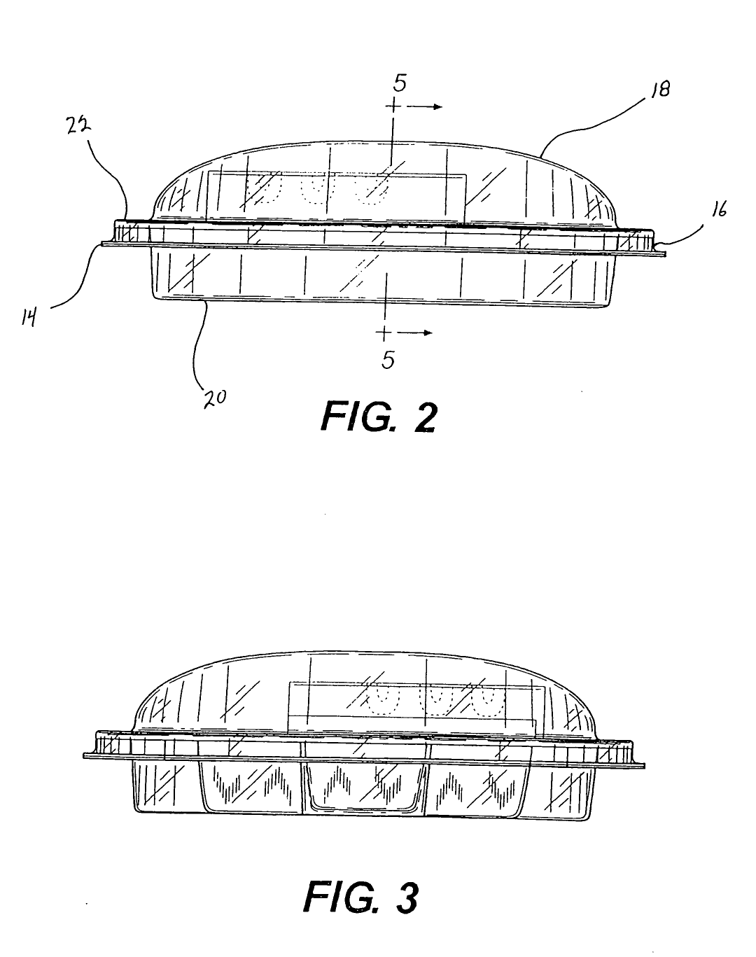

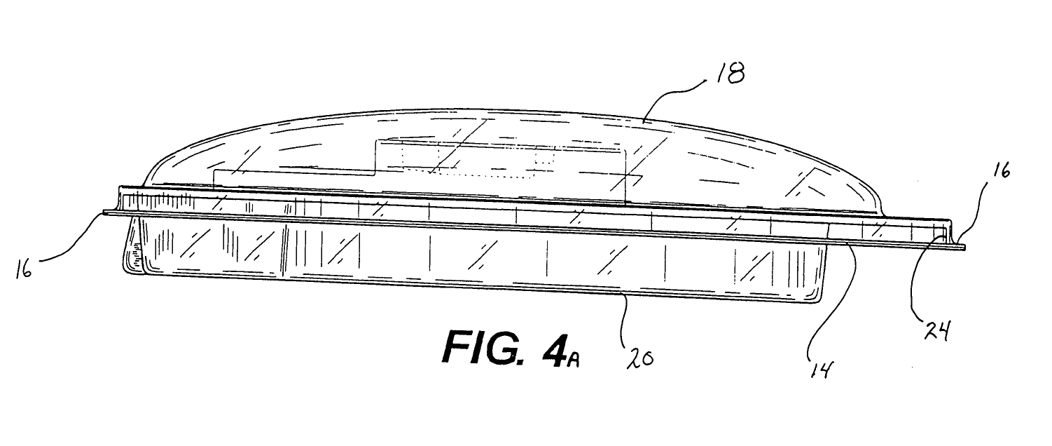

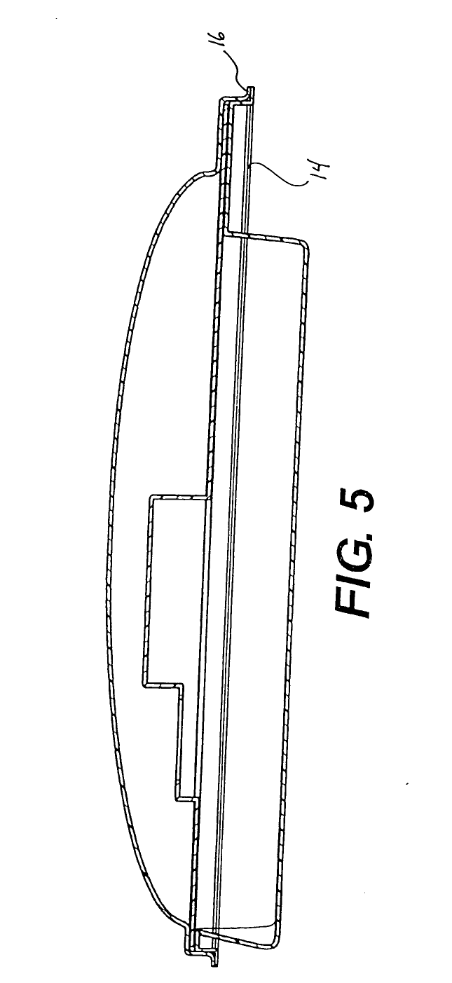

FIGS. 1-5 show an exemplary clamshell package 10 having an edge 14 and an adjacent welded flange 16 around the periphery of the package. A top clam portion 18 is joined with a base portion 20 via the welded flange 16. Either or both halves 18 and 20 may include a relatively flat face 22 surrounding the enclosed product, inboard of the welded flange 16. The clamshell package can include a hanging hole 12 for allowing the sealed clamshell package to be hung on a display rack. In other forms (not shown), the clamshell can include molded feet like structures in the bottom which enable the sealed clamshell package to stand on t a display counter, or in a display box.

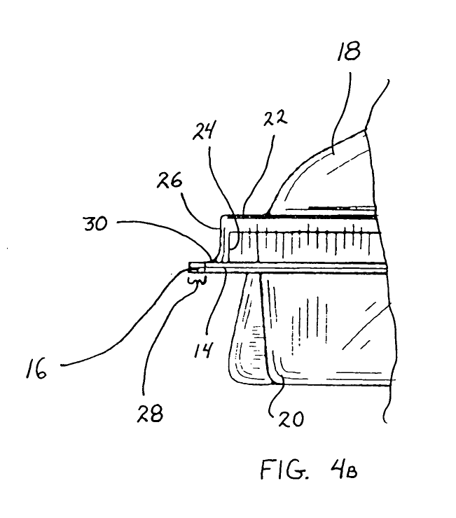

Referring to FIG. 4b, the flange 16 includes a portion 28 along the outer most periphery where the actual heat is applied and the upper clam 18 and lower package 20 are physically connected. The upper clam 20 has a lower portion 26 that may nest with the upper portion 24 of the lower package 18 to help align the two halves of the package. As shown, the assembly includes the sealed portion 28 and an adjacent portion 30 where the upper clam 20 and lower package 18 are nested together often with some clearance, but not sealed. It is in this area of adjacent portion 30 where it is preferred to open the package since any display inserts which are commonly sandwiched between the clamshell halves 18 and 20 in area 22 and/or any products contained in the package are not likely to be damaged during opening.

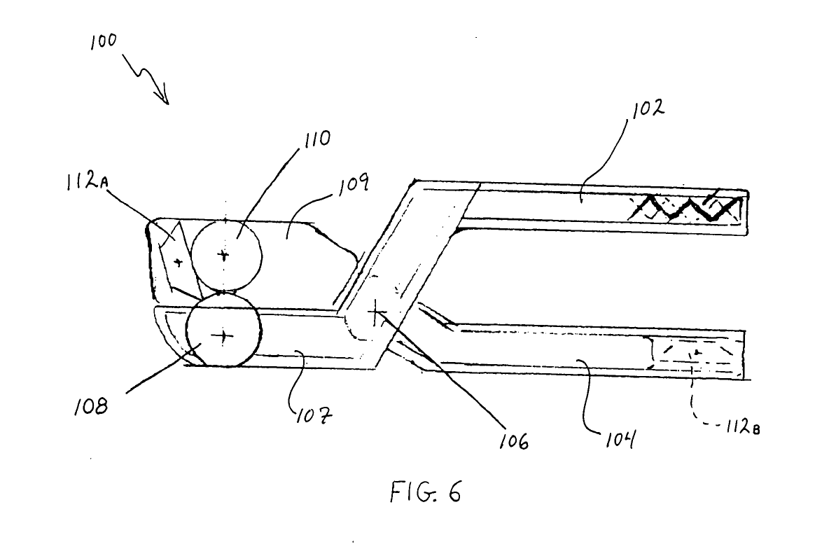

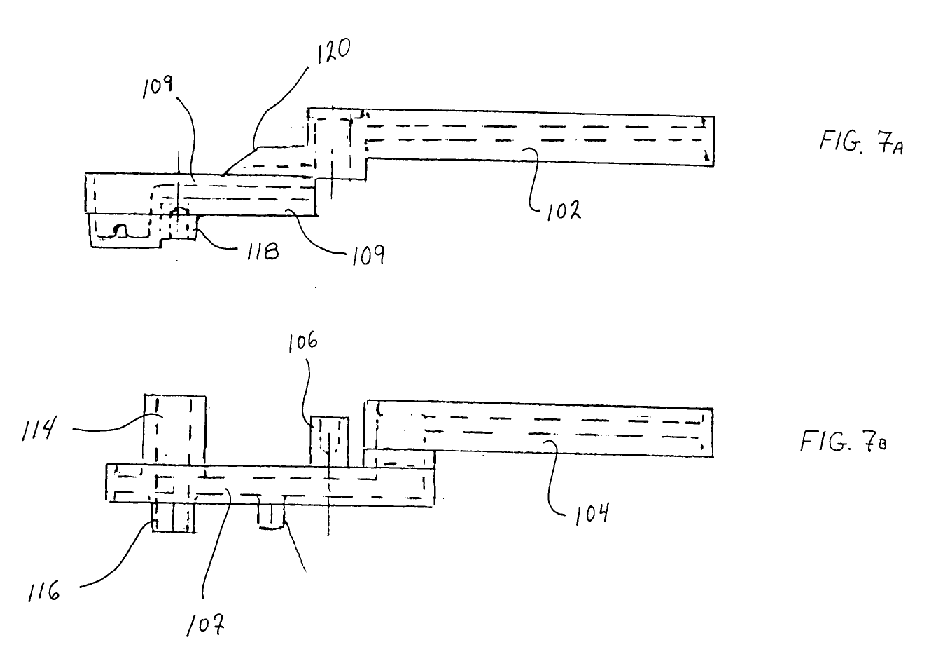

Referring to FIGS. 6 and 7, there is shown a clamshell package opener 100 according to an embodiment of the invention. As shown, the opener 100 includes a scissor like or can opener like construction having a first arm 102 pivotally connected 106 to a second arm 104. The pivot connection 106 between arms 102 and 104 can be any suitable known pivot connection.

First arm 102 includes lower portion 107 that includes a driver gear 108 that is mounted within a driver gear boss 116, and which is driven by a turn handle (not shown) connected to the turn knob boss 114. The second arm 104 includes an upper portion 109 that includes an idler gear 110 and a cutting blade 112a. A second blade 112b can be stored in the handle portion of arm 104 or arm 102, depending on design choices made during manufacturing.

The angular position of the handle arms 102 and 104 with respect to the gears 108 and 110, and the blade 112 can be modified to provide sufficient clearance to the operator while performing the cutting operation and also to allow the clamshell package to pass through the tool unobstructed. By way of example, when the top clam portion 18 or bottom portion 20 are such that they extend close to the welded flange 16, additional clearance of the arms 102 and 104 may be required in order for the tool to engage the package in an area, such as, for example, the welded edge, and move along the same without interfering with the rest of the package.

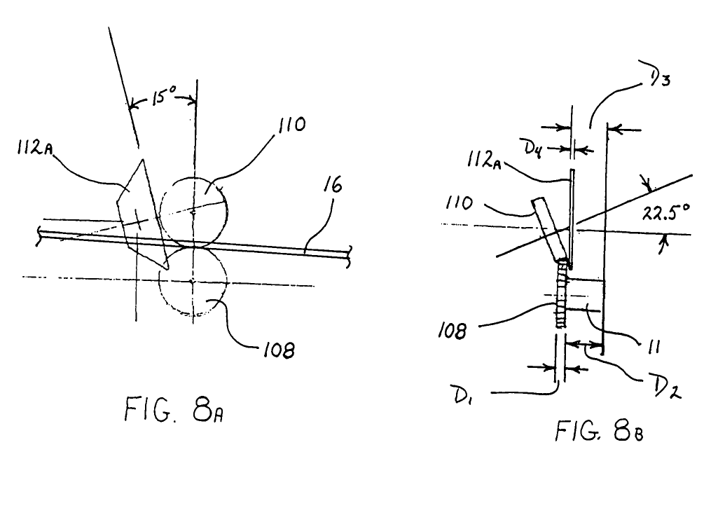

As will be explained with reference to FIGS. 8a and 8b, when the arms 102 and 104 are opened, the driver gear 108 is separated from the idler gear 110 and blade 112a to allow the insertion of the welded flange 16 and edge 14. When the arms 102 and 104 are closed, the driver gear 108 and idler gear 110 secure the clamshell and allow the blade 112a to puncture the flange 16 in the area 30 adjacent the edge 14. This initial puncturing is very integral to the performance and functioning of the clamshell opener 100 according to the invention.

Further closing of the arms forces the driver gear 108 into the bottom side of the welded edge 14 while the idler gear 110 frictionally engages the upper side of the welded edge 14. The closing of the arms and frictional engagement of the driver gear 108 and idler gear 110 with the flange 16 provide for clamshell opening operation. Once the initial puncture by blade 112a into the area 30 adjacent the sealed portion 28 is made by the closing of the arms, the driver gear 108 is rotated by the turn knob (not shown) and the frictional engagement of the driver gear and idler gear 110 with the flange 16 causes the tool to advance the flange 16 through the gears and cut the clamshell package in the area 30 adjacent the sealed portion 28 of the flange 16.

According to another preferred embodiment where the clamshell packages, the opener 100, 900 can engage the clamshell in areas other than the welded edge 14. By way of example, driver gear 108 can engage the upper portion 18 of the clamshell while the idler gear 110 engages the underside 20 of the clamshell. In this embodiment, when the driver gear 108 is rotated, the blade 112a traverses across the clamshell package at any point of the same. Those of ordinary skill in the art will recognize that the opener 100 may have different sizes and shapes without departing from the spirit of the invention.

Referring to FIG. 8b, there are shown various measurements D1-D4. These measurements are positioned to provide proper operation of the clamshell opener according to the invention. By way of example, D1, which is the thickness of the driver gear 108, must be able to engage the clamshell in the track, D2, which is the distance of the driver gear hub 116 from the face of the tool is to allow the clamshell to clear the holding arms while being cut and passing through, D3, which is the distance between the face of the tool and the blade 112a, is to allow the blade to puncture into the clamshell and be supported by the drive gear 108, and the thickness D4 of the blade 112a is of sufficient strength to puncture the clamshell when the driver gear 108 and idler gear 110 are brought together by closing of arms 102 and 104.

As shown, the idler gear 110 is positioned at an angle with respect to the driver gear 108 and thereby a horizontal line passing there through. The preferred angle for mounting and operation of the idler gear is sufficient to apply pressure to the clamshell and hold it in a horizontal position during cutting. By way of example, the mounting angle of the idler gear 110 can be, but is not limited to, approximately 22.5 degrees with respect to the horizontal. The angular mounting of the idler gear 110 with respect to the driver gear 108 facilitates movement of the flange 16 through the gears and thereby enables the cutting of the clamshell package.

The materials that idler gear 110 and driver gear 108 are made of can be a matter of design choice. However it has been determined by testing, that the idler gear 110 is preferably made of a non-skid material and which has a sufficiently high coefficient of friction so that it may compress against the package flange 16 during operation and thereby provides an increased frictional engagement between the opener and the package. Driver gear 108 can be a serrated wheel or friction wheel that is made of metal or other material that can dig into the plastic clamshell to provide traction to advance the opener through the package during operation of the opener.

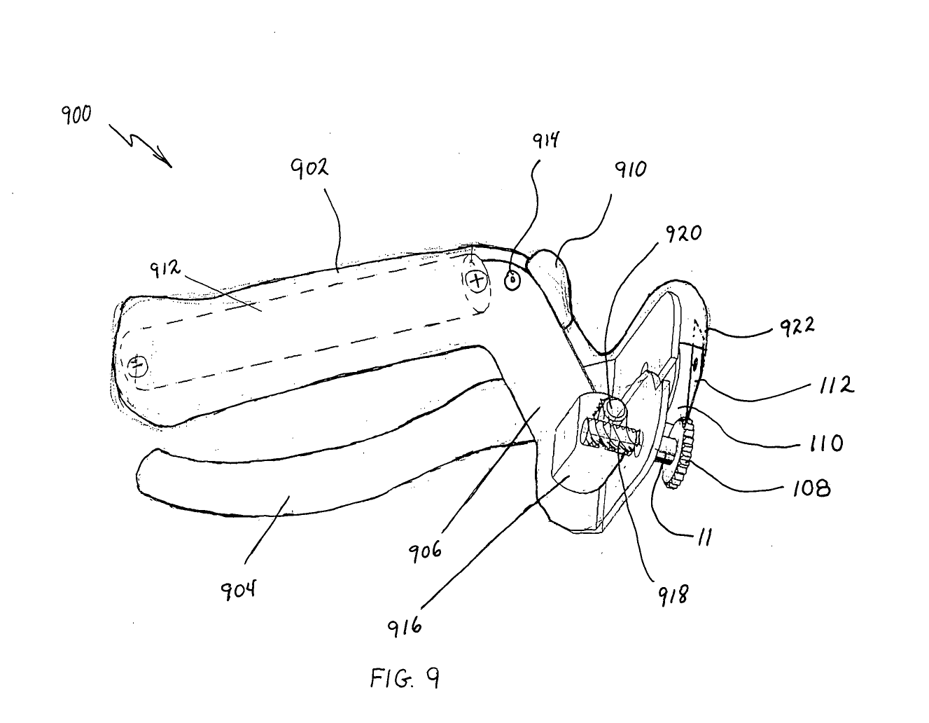

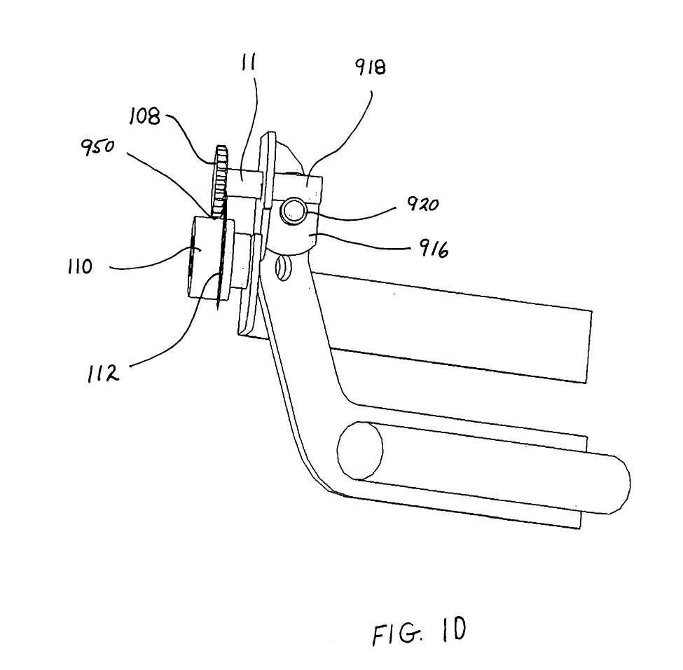

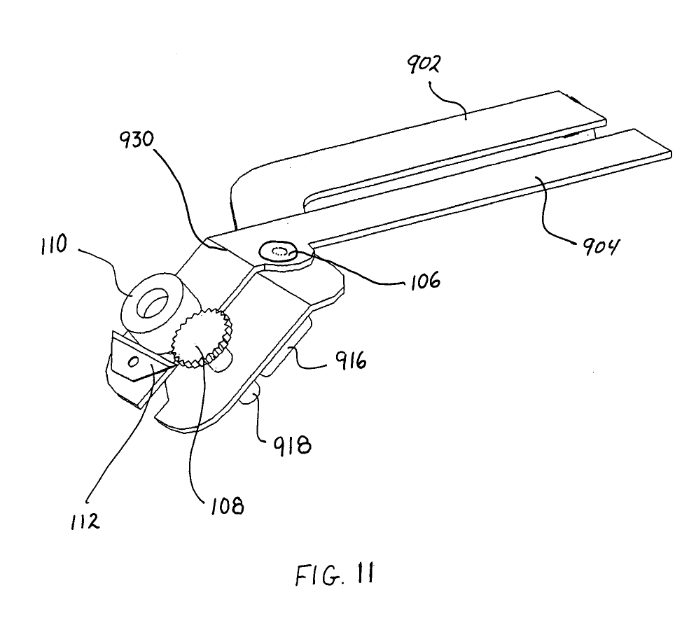

FIGS. 9-11 show a motorized embodiment of opener 900 according to the invention. Opener 900 includes arms 902 and 904 that are ergonomically designed to fit within a user's hand (e.g., left or right hand configured). Arms 902 and 904 are angled 906 to allow the head portion with the blade 112 and rollers 108,110 to engage the clamshell package without the arms interfering with the package during cutting.

A motor 916 is mounted such that a gear 920 engages a gear 918 that is integrated into the shaft 11 of the driver gear 108. The switch 910 is electrically connected to the battery 912 and the motor 916. When the opener 900 is closed, driver gear 108 and idler gear 110 are compressed against the clamshell packaging such that blade 112 punctures the same. Once punctured, and the switch 910 is activated, the motor 916 drives the driver gear 108 through gears 920 and 918. The driver gear 108 will push the packaging along while the blade 112a cuts the same.

Opener 900 includes a battery 912 that may be replaceable or rechargeable depending on the desired application. When battery 912 is rechargeable and not replaceable, a charging port or AC connection port 914 is provided. The port 914 can be used to charge the batter 912, or allow the opener 900 to operate using AC power.

In accordance with another embodiment, switch 910 has an auto shut off mode that can be triggered by the passage of the packaging though the gears 108 and 110 and a determination of the amount of friction/resistance (or more particularly the lack thereof) when the cutting is complete and the package has passed entirely through the gears. In another embodiment, switch 910 is integrated into or electrically connected to the pivot point 106, such that when the opener is closed beyond a predetermined point (i.e., pivot point), the motor 916 is actuated and automatic packaging opening is performed. When the arms 902, 904 are closed, the motor 916 will disengage.

The blade 112 can be any suitable cutting device and is preferably contained within a housing or the like such that only the required tip of the blade is exposed. As shown in FIG. 9, the plastic housing of the opener can include a portion 922 that operates to enclose the part or all of blade 112 that is secured within the opener and not actually used during the cutting action of the device. Portion 922 also operates as a protection device to prevent accidental contact with blade 112. The Safety guard aspect provided by portion 922 also allows tool 900 to be easily stored without concern for cutting a casual handler of the tool.

While there have been shown, described and pointed out fundamental novel features of the invention as applied to preferred embodiments thereof, it will be understood that various omissions, substitutions and changes in the form and details of the methods described and devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed, described or suggested form or embodiment as a general matter of design choice. It is the intention, therefore, to be limited only as indicated by the scope of the claims appended hereto.

1. A clamshell package opener comprising:
means for gripping the clamshell package;
a cutting device for engaging, puncturing and cutting the clamshell package; and
means for advancing the package opener along the clamshell package after said cutting device has punctured the package.

2. The clamshell package opener according to claim 1, wherein said means for gripping comprises:
a first gear; and
a second gear mounted such that said first and second gears are closeable so as to engage the clamshell package there between.

3. The clamshell package opener according to claim 2, wherein said first gear comprises an idler gear and said second gear comprises a driver gear.

4. The clamshell package opener according to claim 2, wherein said advancing means comprises a handle for rotating at least one of said first and said second gears.

5. The clamshell package opener according to claim 2, wherein said advancing means comprises a motor operatively connected to one of said first and second gears and a switch for selectively activating said motor.

6. The clamshell package opener according to claim 5, further comprising a battery for providing power to said motor.

7. The clamshell package opener according to claim 6, wherein said battery is rechargeable.

8. The clamshell package opener according to claim 7, further comprising an AC power/battery recharging connection port.

9. The clamshell package opener according to claim 2, wherein said cutting device punctures an area adjacent the gears when said idler gear and said driver gear are closed onto and engage the clamshell package.
The clamshell package opener according to claim 5, wherein said motor is automatically activated in response to the closing of said gripping means.

10. A clamshell package opener comprising:
a first arm having two opposing ends;
a second arm pivotally connected to said first arm and having two opposing ends;
a first gear rotatably mounted on one end of said first arm;
a second gear rotatably mounted on one end of said second arm that is opposite said first gear, wherein pivotal closing movement of said first and second arms causes said first and second gears to move closer to each other and engage the clamshell package disposed there between; and
a cutting device disposed on one of said arms adjacent one of said gears, said cutting device puncturing the clamshell package in an area adjacent the gears when said arms are pivotally closed.

11. The clamshell package opener according to claim 10, further comprising driving means for advancing the clamshell package opener along the clamshell package when said arms are pivotally closed.

12. The clamshell package opener according to claim 11, wherein said first gear comprises an idler gear and said second gear comprises a driver gear, said driving means comprising said driver gear and means for rotating said driver gear.

13. The clamshell package opener according to claim 12, wherein said rotating means comprises a handle rotatably connected to said driver gear.

14. The clamshell package opener according to claim 11, wherein said driving means comprises a motor operatively connected to one of said first and second gears and a switch for selectively activating said motor.

15. The clamshell package opener according to claim 14, further comprising a battery for providing power to said motor.
The clamshell package opener according to claim 14, wherein said motor is activated when said first arm and second arm are moved into a closed position.

16. The clamshell package according to claim 15, wherein said battery is rechargeable.

17. The clamshell package opener according to claim 16, further comprising an AC power/battery recharging connection port.
